(19) United States
(12) Patent Application Publication
(10) Pub. No.: US 2002/0194722 A1
(43) Pub. Date: Dec. 26, 2002

(54) Portable frog milling machine for use with railroad frog reconditioning and welding table

(76) Inventor: Christopher A. Galloway, Plaistow, NH (US)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/173,121

(22) Filed: Jun. 18, 2002

Related U.S. Application Data
(60) Provisional application No. 60/299,723, filed on Jun. 22, 2001.

(51) Int. Cl. B23P 23/00; B23C 1/00

(52) U.S. Cl. 29/564; 409/235; 409/132

(57) ABSTRACT

A railroad frog positioning and reconditioning table has an I-beam structure designed to support one or more frogs to enable welding repair of defective running surfaces. After defects are repaired with welding material, a portable frog milling machine table is attached to the frog table for positioning of a milling head over the frog which remains on the frog table. The milling head is connected to a support base that traverses the angular iron framework forming the milling machine table through guided sliding movement powered by a rack and pinion drive mechanism. Thus, the milling head cuts the running surface to original profile and an end mill cutting head cuts the frog flange ways to proper profile. The milling head cutting path is movable into straight and angularly offset positions to enable proper contouring.

### RELATED APPLICATIONS

The present application claims priority of U.S. Provisional Application Serial No. 60/299,723, filed Jun. 22, 2001, entitled “Portable Frog Milling Machine for Use with Railroad Frog Reconditioning and Welding Table”, the disclosure of which is incorporated by reference herein in its entirety.

### TECHNICAL FIELD

The present invention relates generally to machines for reconditioning railroad frogs and, more particularly, to machines for milling reconditioned railroad frogs subsequent to welding repair thereof.

### BACKGROUND ART

In the railroad industry, the basic parts of a turnout or track switch are a frog, a switch, guard rails (when required), and a switch stand. The frog is therefore an integral load supporting component of the railroad track switch. The frog component allows the train wheels to move across the plane of the normal running rail during the diverging move through a switch. When a train undergoes a diverging move over a switch, the switch points steer the wheels towards the new direction and the frog creates the gap in the normal running rail to allow the wheel flanges to pass therethrough. To assure a smooth transition over this gap, the frog is constructed with risers and an inclined point to reduce, as much as possible, the impact of the wheels as they pass over the gap. The physics of the action of the wheel passing over this gap requires this component to be constructed of a material that can withstand both the abrasion wear of the train wheels rolling over the frog and the impact resistance of each wheel as it bridges the gap.

Manganese steel is the material used in the construction of railroad frogs due to its work hardening capabilities that resist abrasion wear and stand up well under heavy impact loads. With reference to FIGS. 1-3, the manganese steel is cast into an insert generally designated by reference numeral 10, which is bolted to and surrounded by regular heat treated railroad steel that allows the frogs to be installed in the track structure. Manganese steel can also be used as a complete casting for self guarded frogs which are molded to allow these frogs to be free standing and bolted directly into the track structure.

For example, at one end of frog F, a pair of toe rails 12 and 14 converge towards each other and extend around outer surfaces of a throat portion 16 of the insert 10. These toe rails 12 and 14 are regular heat-treated railroad steel that are mounted to a plurality of railroad ties 15 in a conventional manner and are spaced from each other with a toe block 17 made of cast iron or ductile iron (see FIG. 3A) in an upstream direction from throat portion 16 with a nut and bolt arrangement 19. The throat portion 16, with reference to FIGS. 2 and 3, is molded to define a pair of longitudinally outwardly converging riser sections 21 of insert 10 (see also FIG. 3C) having a pair of inward facing chamfered surfaces 23 in longitudinal alignment with the corresponding support surfaces of the rail heads to define the guideways or flange ways that enable the rail flanges to pass from the toe rails to the gap formed in throat portion 16 of the insert 10 and then into supporting rolling contact with the chamfered surfaces 23. At a point further downstream from the point 25 defining the center portion 27 of the insert 10 (see FIGS. 3D and 3E), the forwardmost ends of a pair of heel rails 29 also of regular heat-treated railroad steel and conventionally mounted to appropriately positioned railroad ties are positioned to continue the flange ways on which the rail wheels are adapted to be supported as they traverse the gap.

The frogs F are subject to wear during normal railroad service and can be maintained in the track to some extent by grinding and performing various amounts of field repair welding as track conditions will allow. However, on a periodic basis, there is a need to remove these frogs from the track environment for rebuilding. Although in some cases it is more economical to simply replace a damaged frog with a new frog, there are many obsolete rail sizes in various commuter rail systems apd, particularly in these situations, it becomes more economical to conduct major rebuilding or reconditioning operations on such damaged frogs.

The proper restoration of a damaged frog requires extensive welding restoration of the frcg F on the running surface or top of the frog in order to remove defects and fatigued metal and to build the manganese to the original cross section such as shown in FIGS. 3B-3G. This type of heavy welding necessitated a fixture on which the frogs F were secured during the welding operation. Moreover, this type of heavy welding causes the entire frog structure to curve upward as a result of intense heat-generated during the welding process. Therefore, it was and is necessary to secure each frog F with a slightly concave deflection to offset this warping tendency.

With reference to FIG. 4, the conventional prior art table structure 30 for supporting the frog F during the welding operation was comprised of a plurality of regular heat-treated steel railroad rails 32 of 15 foot length in which longitudinal edges 34 of adjacent rail bases were welded together base side up in an effort to form a flat support surface 36. A support shaft 38 extended through a space formed between adjacent centrally located rails in which opposite ends of the shaft were received in bearing collars 40 mounted on support pedestals 42.

The foregoing prior art structure 10 suffered from-various drawbacks. For example, the prior art table 10 was not level and the support rail assembly 32 had insufficient stiffness to hold the frog F in the concave deflected position. Consequently, after clamping of the frog F at its opposite ends to the table 10 to initiate the slightly concave frog deflection, this deflection force was often transmitted to the table which then deflected as well resulting in a disadvantageously upwardly curved frog following heavy welding and release from the table.

In addition to the foregoing problems, when rebuilding a frog insert casting 10, after the top surface of the frog is restored with heavy welding material, it is then necessary to rebuild the flange ways 23 with welding material. However, due to the shape of the frog casting, with its deep flange ways 23, it becomes highly advantageous to rotate the frog casting through 90° about its longitudinal axis L in order to horizontally position the flange way 23 to properly conduct this build-up welding. Otherwise, due to the narrowness of the flange ways 23, it is difficult to attain the proper electrode angle. This leads to depositing more metal than is actually needed and necessitates additional time to grind the repaired surface to the proper contour. To reposition the frog in this manner, the prior art frog table 10 depicted in FIG. 4 was rotated using a crane or fork truck with wood blocking then needed to support the table in the turned position. Disadvantageously, this added time and necessitated some degree of difficulty in switching the frog from one position to another position. Since different size frogs must be positioned on this prior art frog table for reconditioning, the table also experienced imbalance and instability while being rotated to different rest positions.

Once the frog has been reconditioned through welding repair, it was then necessary to remove the heavy frog from the reconditioning table and transfer it to another station to surface grind the proper contour of the running surfaces. This operation was performed manually and typically required a good operator to spend four to five hours in order to obtain a good rough ground profile of an average length frog that had an extensive rebuild. The frog was then brought back into the shop in order to have the flange ways ground and the profile finished ground by hand. This hand grinding operation took up to an additional 16 hours, depending on the frog size and the extent of repair.

It is accordingly an object of the present invention to reduce the amount of time required to properly grind the reconditioned frog to a finished profile.

Another object is to minimize the manual effort necessary to achieve final finishing.

Still another object is to grind the frog reconditioned surfaces to a finished profile in a safe and precise manner.

Another object of the present invention is to support frogs for reconditioning on a level surface, followed by performing the aforesaid grinding or milling at the same reconditioning station without removing the frog from the level surface.

Another object is to support frogs on a level support surface that is sufficiently stiff in order to hold the frog in a deflected position during heavy welding.

Another object is to be able to rotate the stiff and level table supporting surface along a longitudinal axis thereof through a range of 180 degrees of lateral positioning with minimal manual effort.

Still another object of the invention is to employ effective locking devices to safely and securely hold the table in different angular orientations.

Yet another object is to provide a table surface that can hold a wide range of different frog lengths and rail sections.

### DISCLOSURE OF THE INVENTION

A portable milling machine, in accordance with a preferred embodiment of the present invention comprises a milling head mounted to a support base and a support frame to which the support base is movably mounted. An attachment frame is connected to extend below the support frame for attaching the milling machine to a supporting structure such as a railroad frog reconditioning and welding table.

At least one slide rail is attached to the support frame and at least one bearing is attached to the support base in sliding contact with the slide rail. A driving mechanism is used to movably connect the support base to the support frame for sliding movement along the slide rail in a longitudinal or X-direction of the machine. In this manner, the milling head, which is manually movably on the support base in Y and Z directions for proper positioning, is operable to cut a stationary object surface to be milled to a proper profile as a result of motorized movement in the X direction.

In the preferred embodiment, the driving mechanism is a motor connected to a pinion in meshing contact with a stationary rack extending longitudinally along the support frame. A gear reducing box may be used to power down the output speed of the motor to an acceptable pinion driving speed.

The support frame is attached to the attachment frame with an attachment mechanism which is operable to enable relative orientation of the support frame and attachment frame such that longitudinal axes of both frames are coaxially aligned with each other in a first orientational position, i.e. parallel to the X-directional axis, and the longitudinal axes are angularly offset from each other in a second orientational position. In this manner, the milling head is used to cut a pair of an object surface to original profile in one direction (i.e. the X-direction) and then, by reorientation of the support frame to the second position, cut another object surface to an original profile which extends in the second angularly offset direction (i.e. at an acute angle to the X-axis).

The attachment mechanism may include a plurality of plates attached to one of the attachment and support frames and a plurality of clamping arrangements attached to the other of the attachment and support frames. Each plate has an arcuately extending slot with the clamping arrangements extending therethrough, whereby unclamping permits relative rotation about a rotational Z-axis and clamping fixes the relative positions of the frames.

In the preferred embodiment, the radii of curvature of these arcuate slots have a common center coincident with the rotational vertical axis. The clamping mechanisms are preferably nuts and bolts.

The attachment mechanism further includes a piston attached to one of the support and attachment frames and a piston rod extending therefrom to contact the other of the support and attachment frames. Movement of the piston rod in one direction tends to separate the frames in the Z-direction to permit the frames to move in their respective X-Y planes between the first and second orientational positions. Preferably, a low friction material (plastic sheet) is positioned between the frames to facilitate such movement.

In the preferred embodiment, the piston is a lifting piston connected to the lower attachment frame and the piston rod is connected to the upper support frame, whereby rod extension is operable to lift the upper frame from the lower frame.

The piston is mounted in the overhead position above the frames through a first connecting frame projecting upwardly from the attachment frame. The piston rod is attached to the support frame through a second connecting frame projecting upwardly from the support frame. A bearing connects the piston rod to the second frame to permit the rotational movement.

The milling machine table of the invention can be mounted on top of a railroad frog reconditioning and welding table to cut restored frog surfaces to original profile without removing the frog from the frog table. The railroad frog reconditioning and welding table, in accordance with a preferred embodiment of the present invention, comprises a table including a pair of longitudinally extending support beams and a stiffener plate assembly including a plurality of transversely extending stiffener plates attached to the support beams at longitudinally spaced intervals from each other. A pair of clamping members are adapted to be operatively connected to the table for clamping the frog at opposite ends thereof by applying a clamping force directed downwardly towards the support beams. Preferentially, a spacer bar is adapted to be placed between a center portion of the frog and the support beams to impart upward longitudinal deflection of the frog center in cooperation with the clamped ends thereof.

The foregoing reconditioning and welding table provides a robust construction capable of resisting any tendency to warp or ‘banana’ when the frog is clamped to the table and deflected in order to itself resist a tendency to banana that would otherwise occur as a result of the heat imparted to the frog during the heavy welding restoration process. In the prior art, less robust reconditioning and welding table constructions experienced undesirable deflection as a result of deflection forces transmitted thereto from the railroad frog loaded in longitudinal deflection. The present invention avoids these prior art problems.

In the preferred embodiment, the pair of support beams includes a pair of I-beams extending in parallel spaced relation to each other. Each stiffener plate is of rectangular configuration having cut out corners dimensioned to interfit with an inwardly extending flange of an associated one of the I-beams so that the upper and lower edge surfaces of the plate are respectively coplanar with associated upper and lower surfaces of adjacent I-beam flanges. The cut out corners may be further configured so that side edges of the stiffener plate extending between the upper and lower edge surfaces are in full contact with inwardly facing surfaces of the associated I-beam web extending vertically between the flanges. Preferably, all contact edges between each stiffener plate and I-beam are welded to ensure such robust construction.

A support member in the form of a heavy steel top plate is preferably secured to the I-beam upper surfaces to define an upwardly directed table support surface thereon. The top plate is not necessarily an integral reinforcement component of the robust table construction in which the longitudinally extending support beams in combination with the stiffener plate assembly are being essentially relied upon to provide a stable flat working or clamping surface resisting longitudinal deflection forces as discussed above.

The reconditioning and welding table of the present invention, in accordance with another feature, further comprises a support shaft extending longitudinally through the stiffener plate assembly. A pair of bearings are located at opposite ends of the support shaft in rotary supporting engagement therewith. A rotating arrangement is operatively connected to at least one and preferably both of the ends of the support shaft for enabling controlled rotation of the table about the longitudinal axis of shaft rotation. This rotation enables the table and frog being worked upon to rotate to different angular positions so as to enable workmen to have easier access to surfaces of the frog being reconditioned (e.g., flange ways formed in the manganese steel insert of the frog) that are not easily accessed when the table is in the horizontal position.

The bearings are preferably pillow block bearings attached to a respective support pedestal adapted to be positioned on a floor supporting surface.

The feature of providing a hand wheel and worm gear arrangement enables the workman to easily rotate the table into a selected angular position to perform the further work. Once in a predetermined angular orientation, such as 45° or 90°, the table may be easily locked into this position by means of a unique locking device operatively connected to selectively lock the table at predetermined angular orientations. In one embodiment, the locking device may be a pin type locking device installed at one or both ends of the table. The pin type locking device may include a circumferentially extending plate or collar bolted to one of the shaft ends for rotation therewith about the rotational axis. This movable collar moves in a transverse plane parallel to a locking plate fixedly bolted to the support pedestal in adjacent outwardly spaced relationship from the pillow block bearing. The fixed locking plate is formed with a series of circumferentially spaced longitudinally axially extending openings adapted to become aligned with a corresponding opening formed in the collar as the shaft and table rotate. In this manner, a locking pin may be inserted through the collar movable opening when it is selectively aligned with one of the locking plate openings to easily secure the table in its predetermined angular orientation in a safe and reliable manner. It will be understood that the aforementioned pin type locking device is located within easy reach of the hand wheel.

The stiffener plates are preferably located at longitudinally spaced intervals that are coincident with the tie-down attachment ears to thereby provide stiffening reinforcement particularly in the vicinity of the clamping points along the table. In addition, the support beams are preferably pre-stressed so that the table is slightly arched in the absence of supporting a load thereon. This pre-stressing enables the table to resist undesirable longitudinal deflected when one or more frogs are bolted the table.

Still other objects and advantages of the present invention will become readily apparent to those skilled in this art from the following detailed description, wherein only the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a perspective view of a rail bound manganese steel frog with a light type insert or center as recommended for light and medium heavy traffic service;

FIG. 2 is a top plan view of the frog depicted in FIG. 1;

FIG. 3 is a scaled top plan view of a rail bound manganese steel frog similar to the frog depicted in FIG. 2;

FIG. 3A is a sectional view taken along section line 3A-3A of FIG. 3;

FIG. 3B is a sectional view taken along line 3B-3B of FIG. 3;

FIG. 3C is a sectional view taken along line 3C-3C of FIG. 3;

FIG. 3D is a sectional view taken along line 3D-3D of FIG. 3;

FIG. 3E is a sectional view taken along line 3E-3E of FIG. 3;

FIG. 3F is a sectional view taken along line 3F-3F of FIG. 3;

FIG. 3G is a sectional view taken along line 3G-3G of FIG. 3;

FIG. 4 is a perspective view of a prior art frog table;

FIG. 5A is a perspective view of a frog reconditioning workshop utilizing frog positioning and welding tables in accordance with the present invention;

FIG. 5B is an enlarged perspective view of one of the frog tables of FIG. 5A;

FIG. 6 is a perspective view of a grinding station for initially processing defective areas of a frog to be reconditioned before the frog is placed on the frog table;

FIG. 7 is a perspective view depicting the manner in which the table is reinforced in accordance with the invention;

FIG. 8 is a perspective view depicting other features of the table;

FIGS. 9A-9C are side and top views depicting removable tie-down nuts for use with the frog table of the present invention.

FIG. 10 is a perspective view of the milling machine table of the present invention in a position suspended over the frog reconditioning table and prior to attachment thereto;

FIG. 11 is a perspective view of the milling machine table of FIG. 10;

FIG. 12 is a perspective view of the milling head of the table;

FIG. 13 is a front view, partly in perspective, of the milling head;

FIG. 14 is an enlarged perspective view of the rack and gear drive motor attached to the milling head;

FIG. 15 is a perspective view of the milling head in operative cutting engagement with a reconditioned railroad frog in a first orientational position of the table;

FIG. 16 is a perspective view depicting the milling machine support base in controlled sliding movement along the milling machine;

FIG. 17 is a perspective view similar to FIG. 15 but showing the milling machine in an angularly offset orientational position;

FIG. 18 is a top plan view, partly in schematic form, of a mechanism for rotating the milling head support frame relative to the milling machine attachment frame; and

FIG. 19 is a vertical elevational view, partly in section, depicting the manner in which the milling machine support frame and the attachment frame rotational connect to each other.

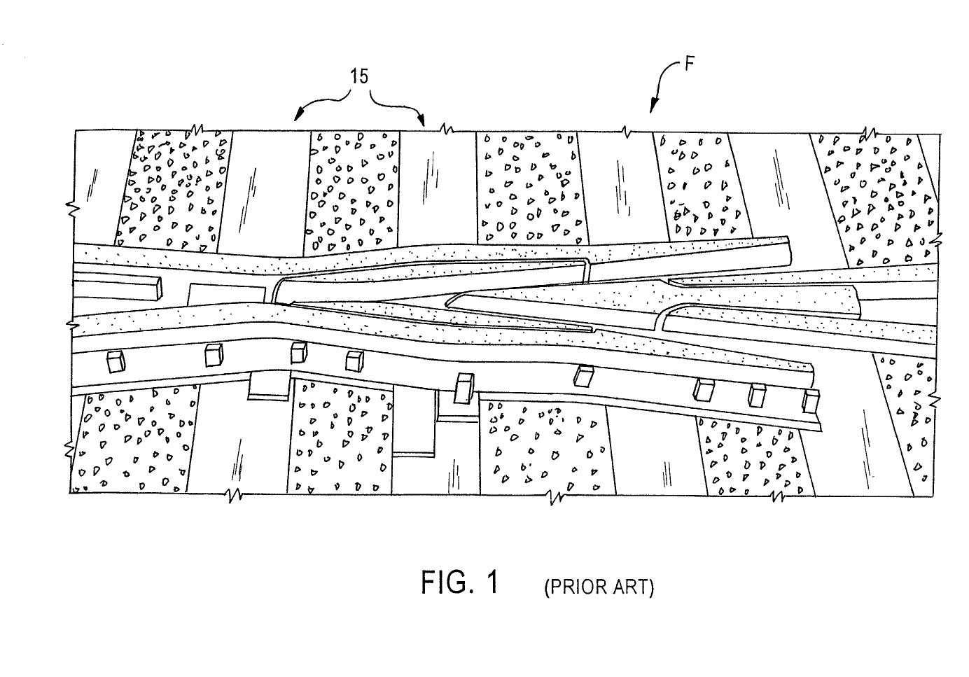

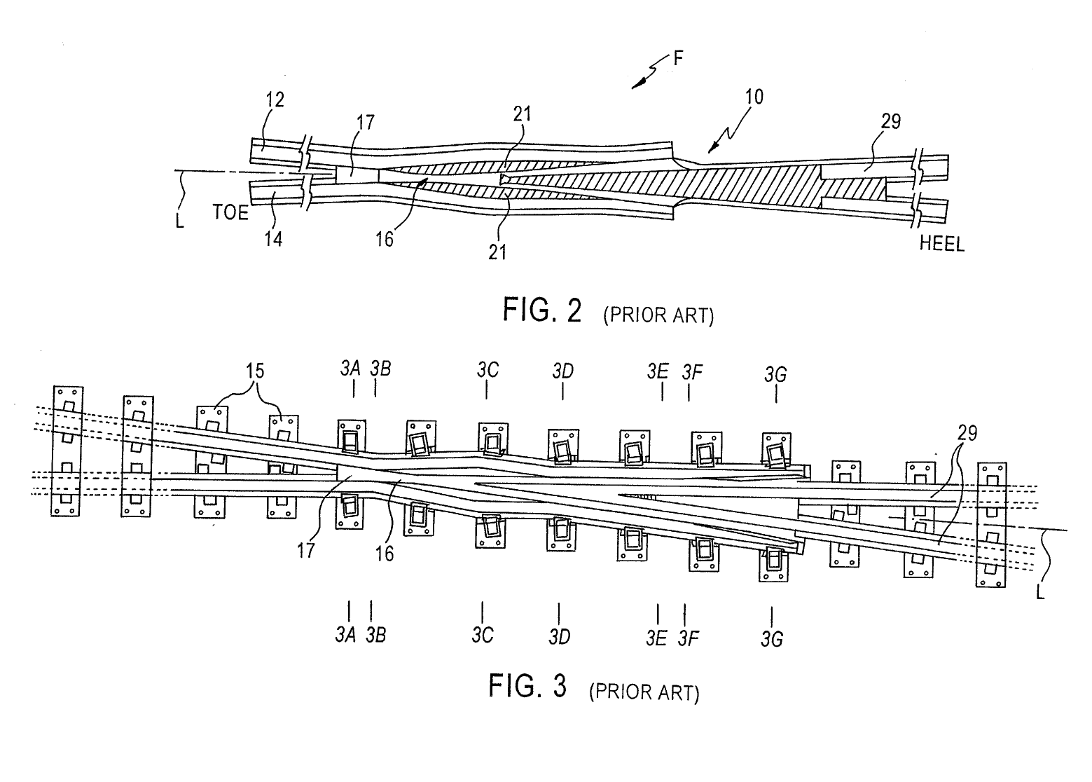

### BEST MODE FOR CARRYING OUT THE INVENTION

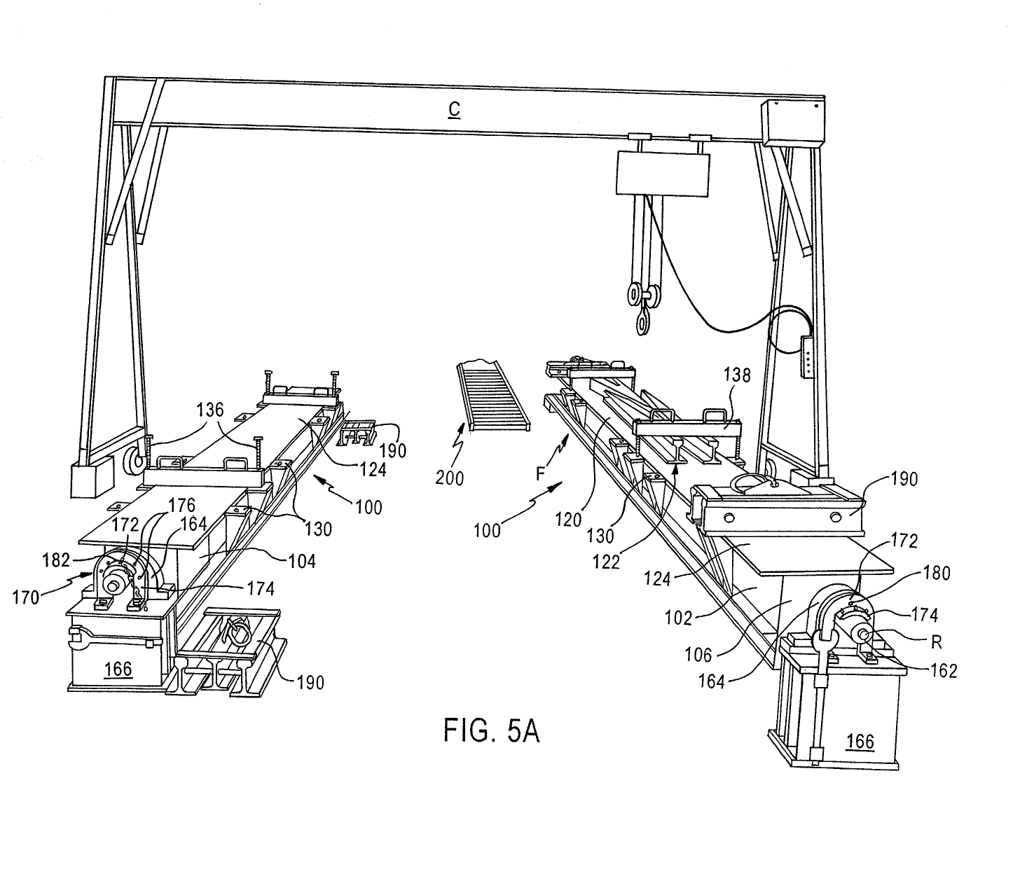

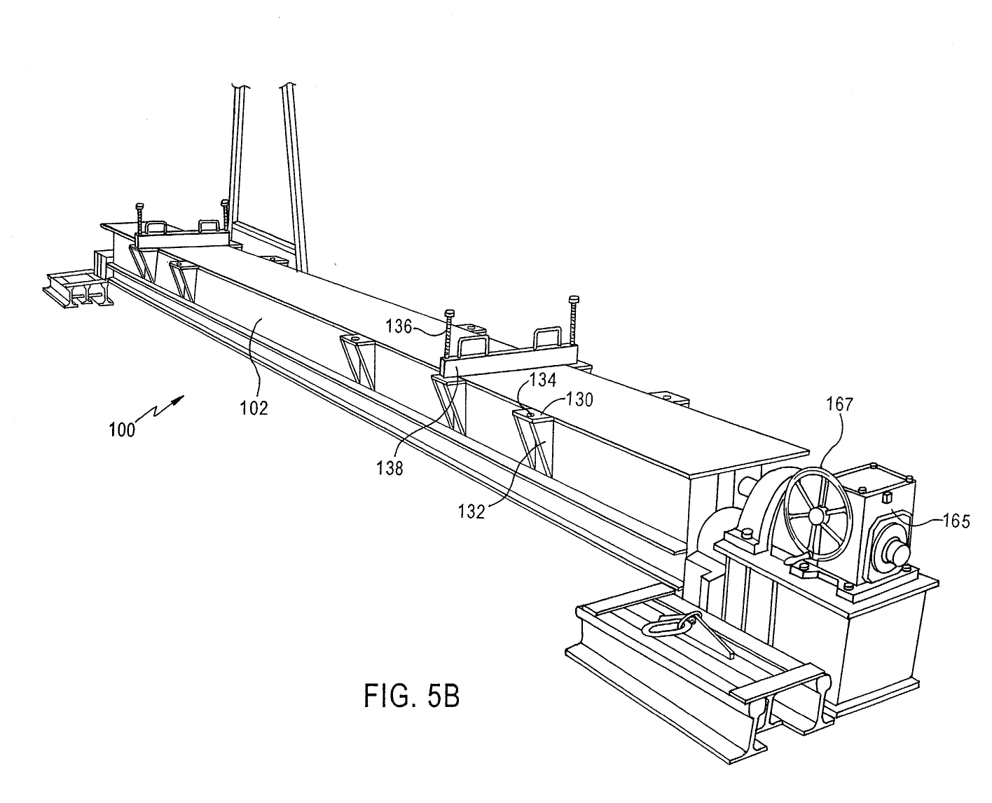

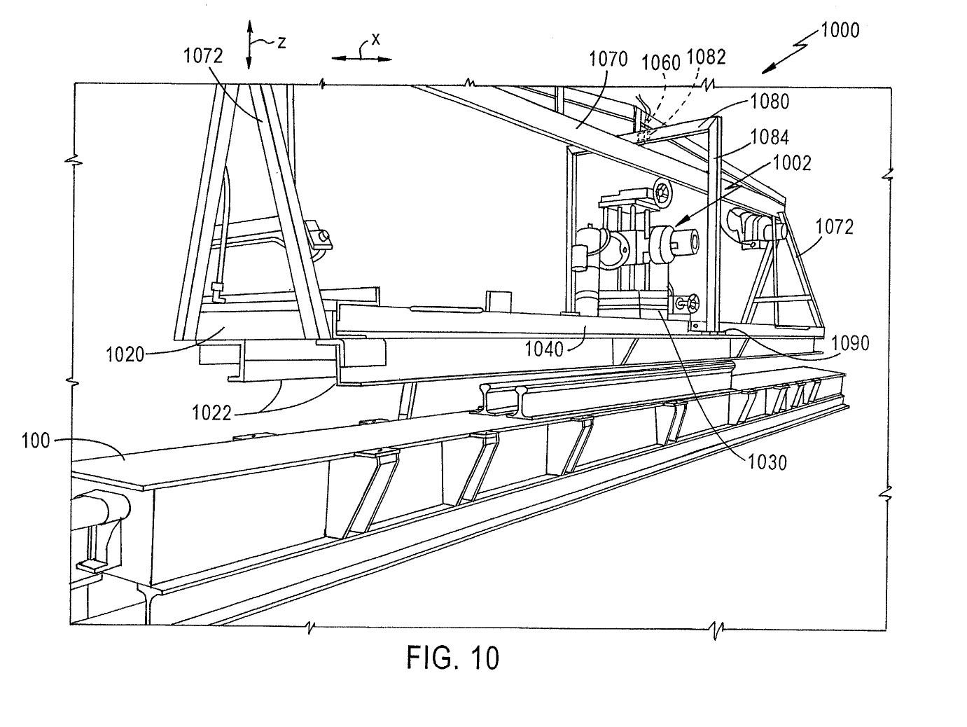

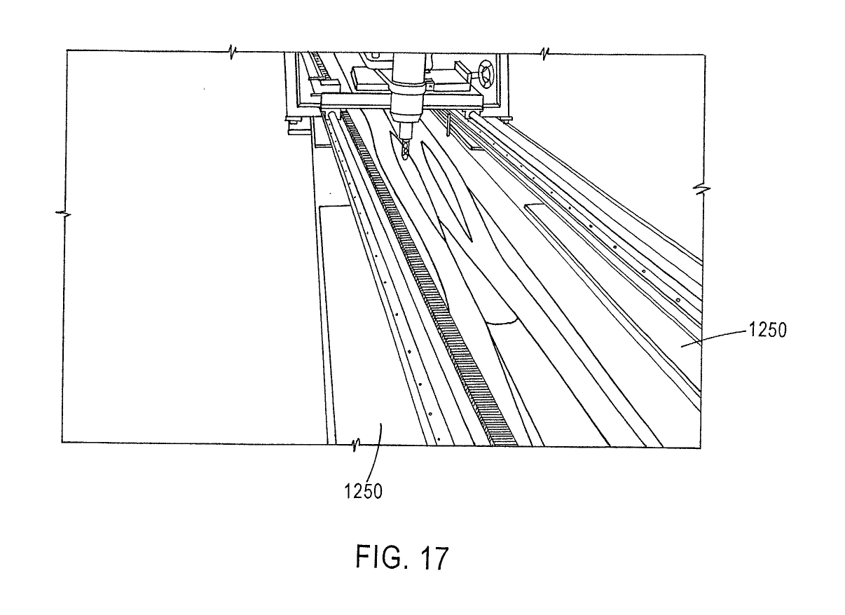

FIGS. 5A and 5B are perspective view illustrations of a unique rotating frog table, generally designated with reference numeral 100, that is designed to support and secure various lengths and weights of frogs F during heavy welding as required during the frog restoration process, without undergoing any internal deflection itself Once the running surfaces and flange ways of the rail portions defined by the frog manganese steel insert are repaired by welding, a unique portable milling machine table, generally designated by reference number 1000, is designed and constructed to be positioned over the frog (see FIGS. 10 and 17) while it remains on the frog table 100 so that the running surfaces and flange ways may be cut to a proper original profile in the unique manner described more fully below.

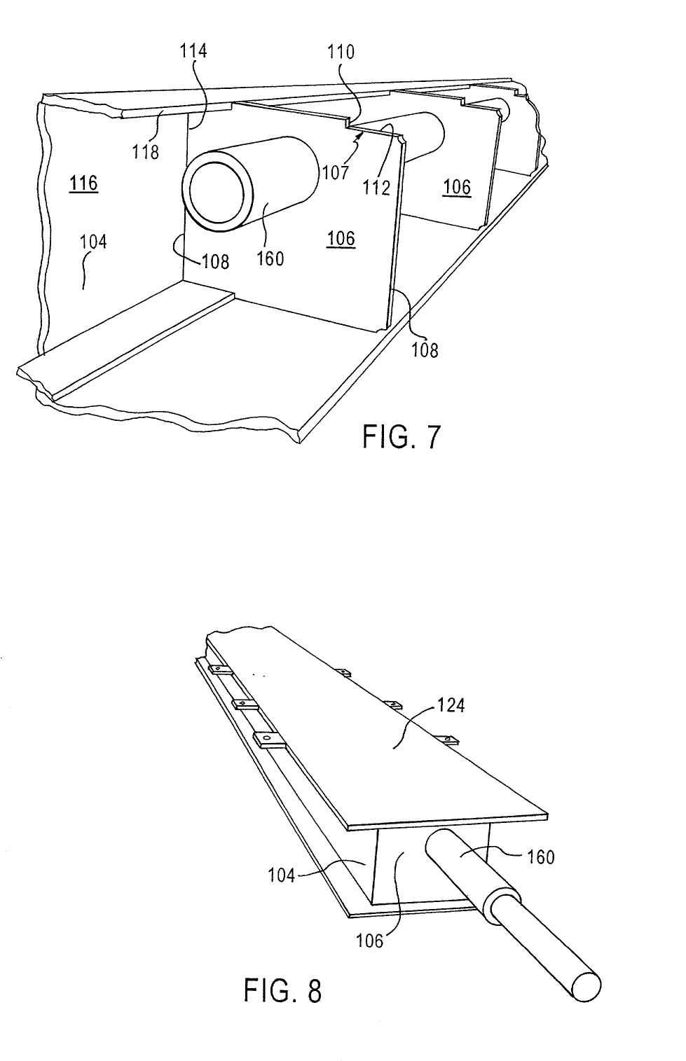

Table 100, in one preferred embodiment, is comprised of a pair of parallel I-beams 102 and 104, each preferably extending the full length of the table. The I-beams 102, 104 are connected to each other through a series of identical transverse rectangular steel stiffener plates 106 that are located at longitudinally spaced intervals along the full table length. Each stiffener plate 106 has cut out corners 107 (see FIG. 7) that enable the vertical edges 108 of the plate and the cut edges 110 and 112 defining each corner to fully contact the inner surfaces 114 of both the I-beam web 116 and inwardly extending flange 118 in welded or other secure engagement therewith. It is this basic skeletal support structure that forms the heart of the novel table 100 of this invention enabling the table to remain straight and level by resisting flexion forces that occur when the frog F is clamped to the table supporting surface by means of a center spacer bar 120 and clamped ends 122 on opposite longitudinal sides thereof

The table top is preferably a top plate 124 that is welded to the top surfaces of I-beams 102,104 and coelevational top and bottom edge surfaces of the transverse stiffener plates 106. In the preferred embodiment, the table top plate 124 may be ¾ inch steel plate that is two feet in width.

Due to the robust construction of the unique arrangement of I-beams 102,104 and stiffener plates 106, the table may have a length of up to 35 feet and preferably in the range of 25-35 feet. For example, a table 25 feet long is capable of holding up to a 23 foot frog in deflection. A table up to 35 feet long is capable of holding two suitably sized frogs in longitudinally spaced relationship from each other and which are clamped to the table at the same time for reconditioning and welding repair.

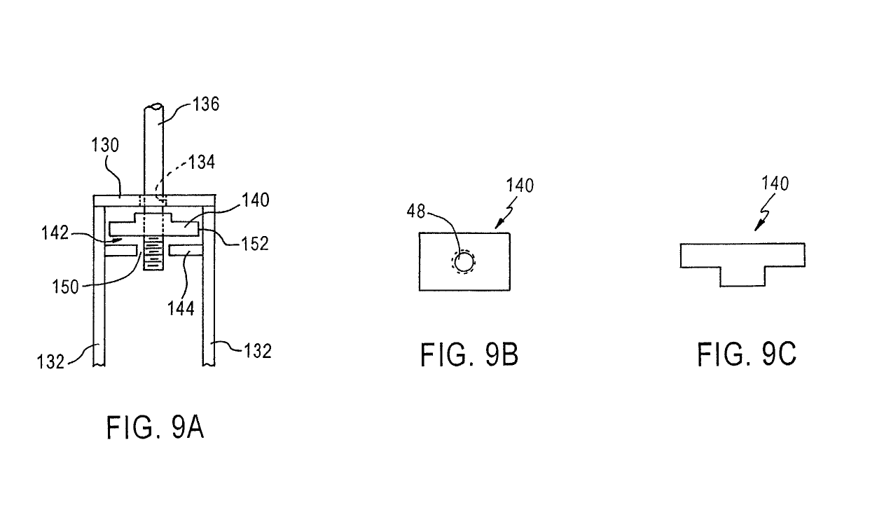

To secure one or more frogs F in clamping engagement with the table, a plurality of pairs of tie-down ears 130 are attached to the sides (I-beam webs 116) of the table, preferably at the same longitudinally spaced intervals as the stiffener plates 106. In the preferred embodiment, with reference to FIGS. 9A-9B, each attachment ear 130 is a horizontally extending plate of rectangular construction in top plan view that has an upper surface coelevational with the table top surface. The attachment ear 130 extends between a pair of vertically extending, longitudinally spaced gussets 132 secured to the outer surface of the associated I-beam web 118 by welding or other method of secure attachment. An opening 134 formed in the ear 130 is capable of receiving a lower end of one clamping bolt 136 extending downwardly through suitable passages formed at opposite transverse ends of the associated clamping bar 138. A nut may be welded in coaxial alignment with the attachment ear opening to permit threaded engagement with the clamping bolt lower end. However, in the preferred embodiment of this invention, a removable tie-down nut 140 is preferably disposed in a cavity 142 formed between inward facing surfaces of the gussets 132, the bottom surface of the attachment ear 130 and the upper surface 144 of a retaining plate that is both parallel and below the attachment ear in welded engagement with the gusset (see FIG. 9A). This arrangement enables the removable nut 140 to be received in the cavity. The removable nut 140 depicted in FIGS. 9B and 9C has a threaded central opening 148 adapted to receive the lower end of the clamping bolt 136 in threaded engagement. A coaxially aligned opening 150 in the bottom plate 144 enables the clamping bolt 136 to extend therethrough as the bolts are screwed to apply clamping force exerted by the clamping bar 138 against the associated frog end. Opposite parallel edges 152 of the removable nut 130 are preferably slightly spaced inwardly from the inward facing surfaces of the gussets 132 so that the gussets prevent rotational movement of the nut as the bolts 136 are screwed into threaded engagement therewith to achieve the aforesaid clamping contact.

A support shaft 160 extends longitudinally through the stiffener plate assembly (see FIGS. 7 and 8) 106 with opposite ends 162 thereof extending respectively through the end stiffener plates in rotary supporting engagement with a pillow block bearing 164 attached to a support pedestal 166 adapted to be supported by the floor surface as best depicted in FIG. 5A. A rotating arrangement is operatively connected to at least one, and preferably both, of the ends 162 of the support shaft 160 for enabling controlled rotation of the table 100 about the longitudinal shaft rotational axis R. This rotation enables the table 100 and frog F being worked upon to rotate to different angular positions to enable workmen to have easier access to surfaces of the frog being reconditioned (e.g. guideways 32 formed in the manganese steel insert 10 of the frog) that are not easily accessed when the table 100 is in the horizontal position.

Although the rotating arrangement may embody different forms, preferably a reducing gear arrangement in the form of a worm gear reducing case 165 (see FIG. 5B) is operatively connected to one shaft end 16 and a hand wheel 167 for rotating the table 100. In other embodiments, the rotating arrangement may include an electric or other type of powered motor, a belt drive arrangement, etc.

The feature of providing a hand wheel 167 and worm gear arrangement 165 enables the workman to easily rotate the table 100 into a selected angular position to perform the further work. Once in the predetermined angular position (e.g. 45° or 90°), the table 100 may be easily locked into this position by means of a unique locking device operatively connected to selectively lock the table at predetermined angular orientations. In one embodiment, the locking device may be a pin type locking device 170 installed at one or both ends of the table 100. The pin type locking device 170, as best depicted in FIG. 5A, may include a circumferentially extending plate or collar 172 bolted to one of the shaft ends 162 for rotation therewith about the rotational axis R. This movable collar 172 moves in a transverse plane parallel to a retaining or locking plate 174 fixedly bolted to the support pedestal 166 in adjacent outwardly spaced relationship from the pillow block bearing 164. The locking plate 174 is formed with a series of circumferentially spaced longitudinally extending openings 176 adapted to become aligned with a corresponding opening 180 formed in the collar 172 as the shaft 160 and the table rotate. In this manner, a locking pin 182 may be inserted through the collar movable opening 180 when it is selectively aligned with one of the locking plate openings 176 to easily secure the table in its predetermined angular position in a safe and reliable manner. In the preferred embodiment, this pin type locking device is located within easy reach of the hand wheel 167 as is apparent from FIG. 5B.

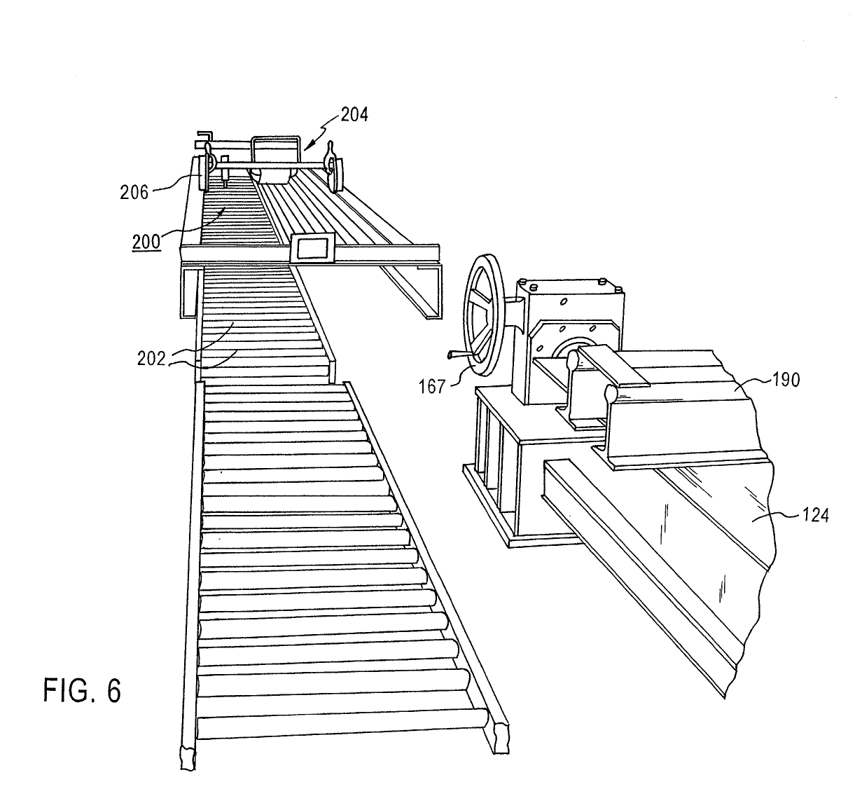

With frog table 100 of the invention, reconditioning of frogs F may now be accomplished in a faster as well as safe and reliable manner. Initially, when the frog F is delivered to the shop for reconditioning, the frog is initially placed in a grinding station consisting of a grinding panel 200 having I-beams, angle irons an a conveyor 202 made out of steel rollers as best depicted in FIG. 6. While on the grinding panel or table 200, the upper surface of the frog to be reconditioned is exposed to a grinding machine 204 preferably mounted on a wheeled carriage 206 for relative movement to enable the work hard material that has become brittle and cracked be grinded from the frog. After grinding, a crane C (FIG. 5A) is used to transfer the frog from the conveyor 200 to the table 100. The spacer bar 120 is placed on the table to contact a center portion of the frog placed thereon. Based on experimentation, a spacer bar of ¾ inch is usually disposed beneath a frog up to 11 feet in length. A one inch spacer bar is used for frogs of 11 to 18 feet in length while a 1-¼ inch spacer bar is used for longer frogs or frogs requiring extensive welding.

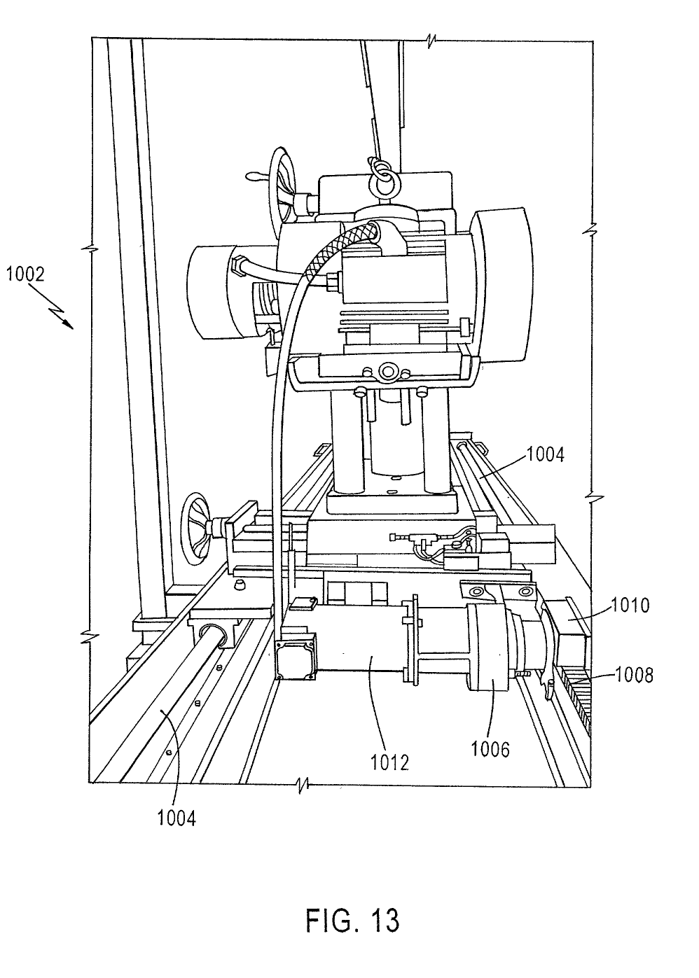

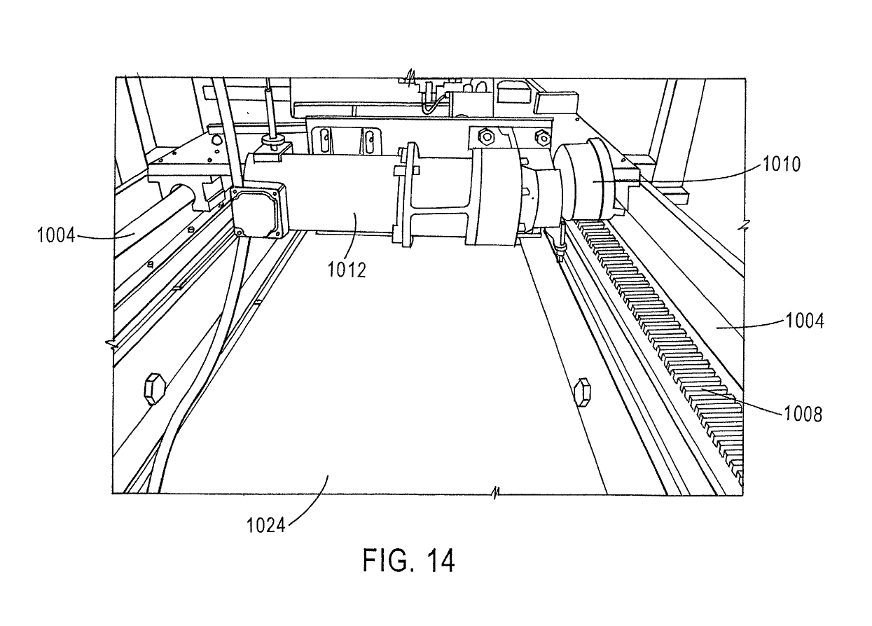

Once the frog F has been reconditioned through welding repair, it is then necessary to final finish the running surfaces of the frog rail to original profile. This final finishing is achieved by means of a unique milling machine, generally designated with reference number 1000, which is uniquely designed to be attached to the top of the frog positioning table 100 so as to be positioned over the frog F which remains on the reconditioning table. The machine 1000, in a preferred embodiment, is composed of a Master milling head 1002 mounted on, for example, a 20 foot length of a Thomas Rail System 1004 supported by an angle iron frame in the unique manner described below. The milling head 1002 traverses the length of the slide rail in the X-direction using, for example, a 119:1 gear reducer 1006 attached to a rack 1008 and pinion 1010 powered by a DC motor 1012 with variable speed control (see FIG. 13). This portable milling machine 1000 can be lifted onto the frog reconditioning table by means of the gantry crane. As discussed more fully below, the angle iron framework is designed to swivel about a vertical rotational Z axis to allow the milling of any flange way angle (i.e. along surface 23) without repositioning the frog F. Therefore, once the welding operation is completed, the milling machine 1000 is mounted over the frog F. A face mill cutting element cuts the running surface to original profile and then an end mill cutting element cuts the flange way 23 to proper profile. This operation substantially reduces the finishing time being spent grinding the frog to proper contours in accordance with the prior art. The milling machine 1000 of the present invention also eliminates hand grinding in favor of a less manually intensive, faster and more precise method of grinding achieved with the milling machine.

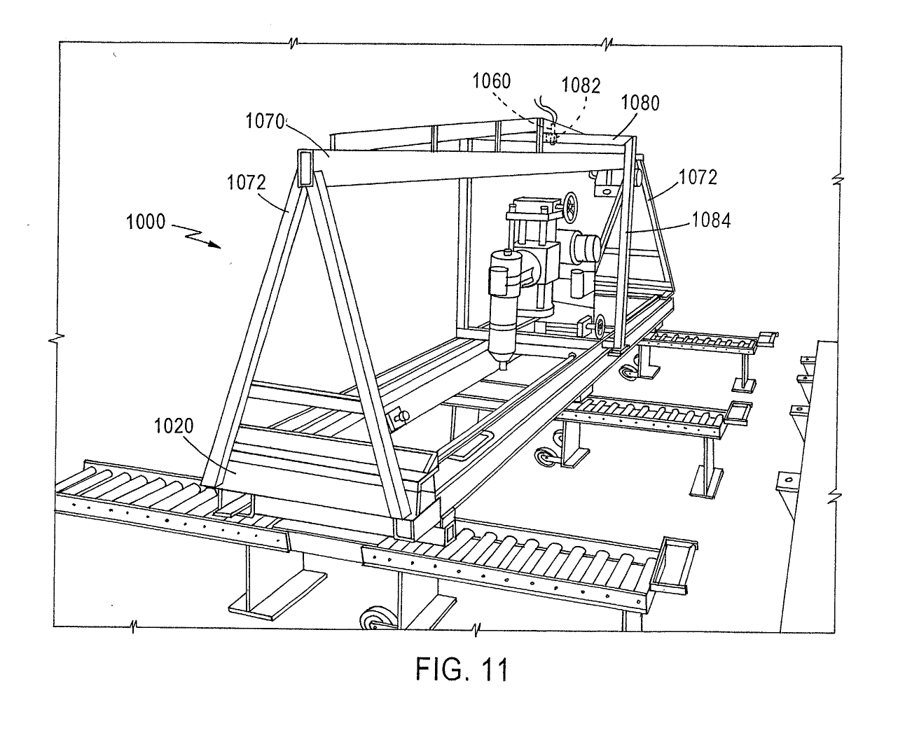

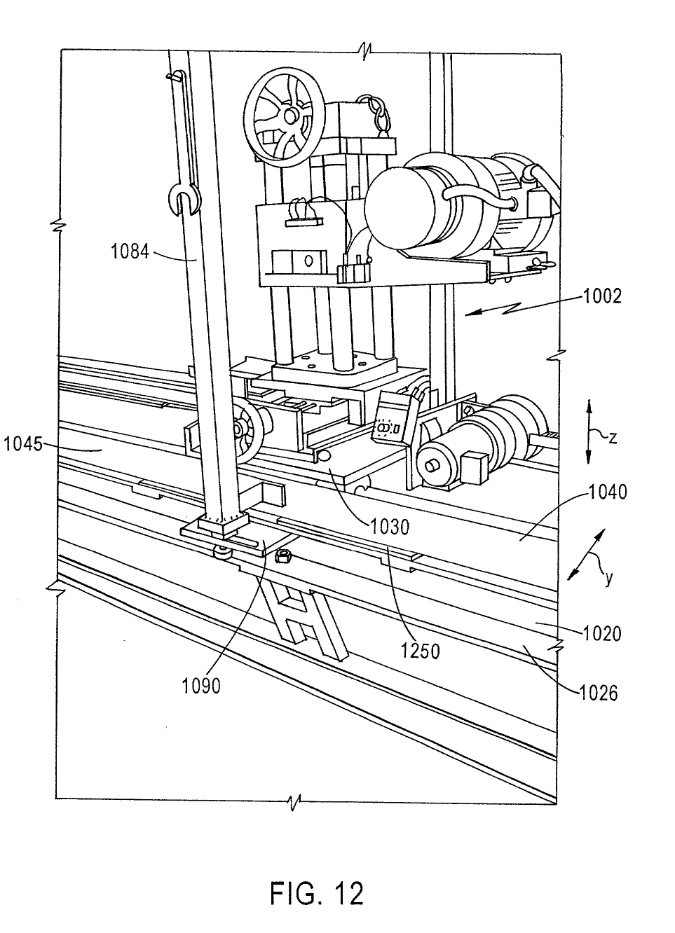

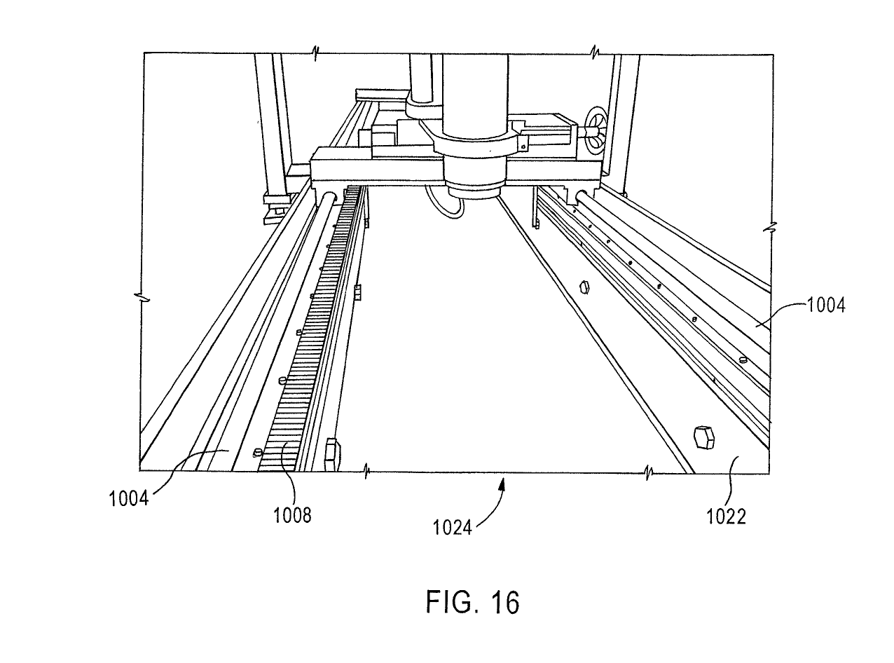

The milling machine 1000 is comprised of a frog table attachment frame 1020 having a pair of parallel rails 1022 (see FIGS. 10 and 11) (e.g. ¾ inch steel angle iron) that are spaced from each other to define a longitudinal frog receiving cavity 1024 (FIG. 16) that is open at top and bottom ends thereof to receive the frog as the frame 1020 is positioned to lie on the welding table 100. The bottom edge of each rail 1022 includes an outwardly extending mounting flange 1026 (best shown in FIG. 12) having mounting holes formed in alignment with the frog table tie-down openings 134 to enable secure attachment of the attachment frame 1020 to the frog table.

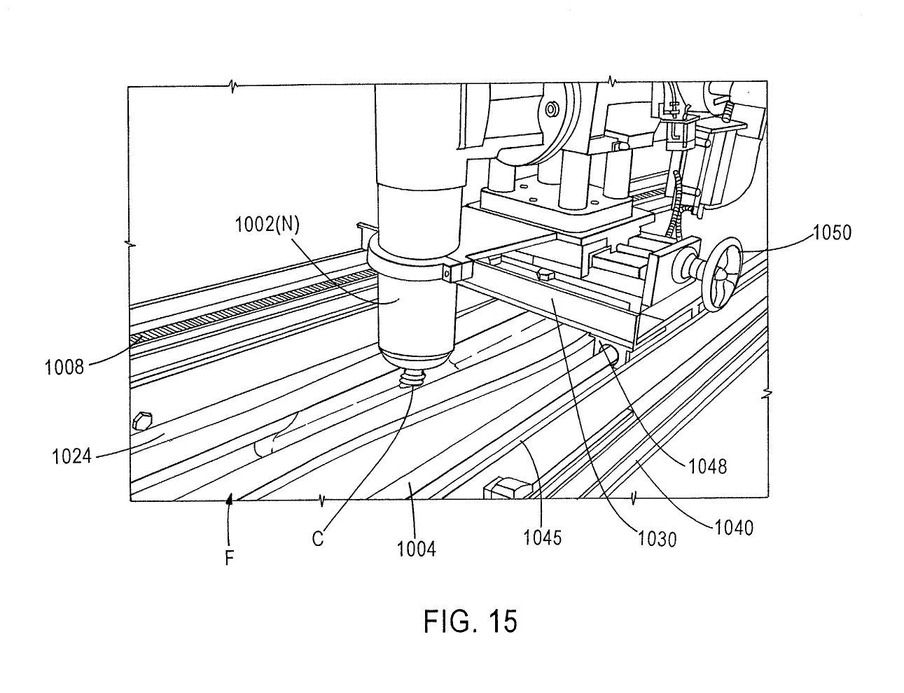

A milling machine support base or table 1030 is connected to the frog table attachment frame 1020, through a support frame 1040 to support the milling machine head 1002 above the frog receiving cavity 1024. In this manner, the frog is exposed to the milling machine cutting elements C which are movably disposed in the cavity 1024 in the unique manner described below and as best depicted in FIG. 15. The cutting elements C include a face mill which cuts the running surface to original profile and an end mill that cuts the flange way 23 to proper profile (FIG. 17). The support framework 1040 includes a pair of parallel angle iron frames 1045 having an upper surface to which is attached a pair of parallel slide rails 1004 and one parallel rack 1008 disposed inwardly adjacent one of the slide rails. The rectangular support base 1030 has four bearings 1048 projecting downwardly at each opposite corner of the base in sliding supporting contact with the slide rails 1004. The base also supports the DC motor 1012 driving the pinion 1010(through the gear reducing box 1006) in meshing contact with the rack. The milling head 1002 further includes a nose cone N supporting the end mill at a lower end thereof to cut the flange ways 23. Both the face mill and the end mill are movable in Y and Z directions with hand wheels 1050 to properly locate the cutting elements within the cavity 1024 to cut the running surfaces of the reconditioned frog.

An amp meter (not shown in detail) is mounted to the support base 1030 to enable the workman to monitor the amps drawn by cutting motor 1002 so as to detect whether the cutting elements C are becoming worn.

A pair of air cooling nozzles 1012 (FIG. 10) are also mounted to the support base 1030 to both cool the cutting edge and blow chips out of the way.

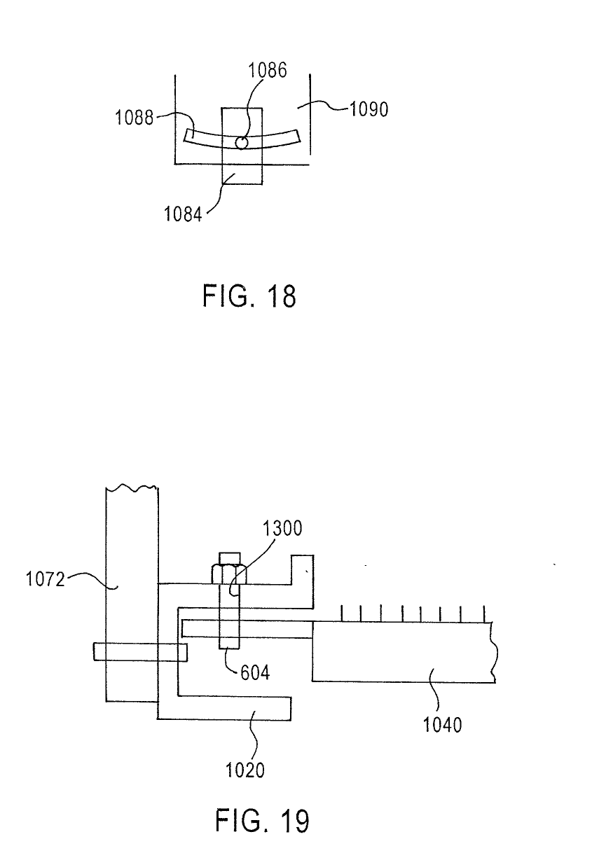

In accordance with a further unique feature of the invention, the upper support frame 1040 is movably mounted to the lower attachment frame 1020 so as to be pivotally adjustable relative thereto about a vertical axis of rotation extending in the Z direction. The vertical axis of rotation is defined by a piston rod 1060 extending upwardly above a center point of the milling machine supporting frame 1040. In the preferred embodiment, a hollow beam 1070 extends above the supporting frame 1040 in the X direction in vertically spaced relation to the supporting frame. Opposite ends of the hollow beam 1070 are attached through a pair of A-shaped end frames 1072 to opposite transversely extending ends of the lower attachment frame 1020. The milling machine support frame 1040 is connected to the distal end of the piston rod 1060 through a turntable bearing 1080 mounted to a transverse beam 1080 extending above and perpendicular to the longitudinal overhead beam 1070 by means of a pair of vertical posts 1084 extending downwardly therefrom on opposite sides of the milling machine. Bottom ends of these vertical posts are formed with a downwardly extending bolt 1086 (see FIG. 18) received in an arcuate slot 1088 formed in a horizontal plate 1090 attached to and extending outwardly from the lower attachment frame 1020. Opposite longitudinal ends of the top support frame 1040 and lower attachment frame 1020 are also attached to each other by means of a somewhat similar nut and bolt arrangement fixed to a support plate at each end of the top frame 1040 such that the bolt extends through an arcuate slot 1300 formed in a juxtapositioned angle iron plate attached to each end of the lower attachment frame (see FIG. 19).

The aforementioned arcuate slots have a radius of curvature in relation to a center coincident with the rotational axis extending through the overhead lifting piston rod 1060. In a closed position, the two frames 1020, 1040 are parallel to each other and the X-axis and the nut and bolt arrangements disposed at the side and ends of the frame are tightened to prevent any rotational or lifting movement of the support and attachment frames relative to each other. In this closed position, vertically aligned bolt receiving collars 1090 attached to the rails at intermediate portions thereof in each of the frames assist in maintaining the two frames parallel to each other so that the slides are parallel to the longitudinal axis of the frog. In this position, a vertical locking bolt interlocks the frames together by extending through the alignment bolt receiving collars 1090 to maintain the desired parallelism. The milling machine support base 1030 can then be actuated to move longitudinally as a result of motorized pinion rotation causing longitudinal movement through meshing contact with the rack. In this manner, the face mill cutting element cuts the running surface to original profile.

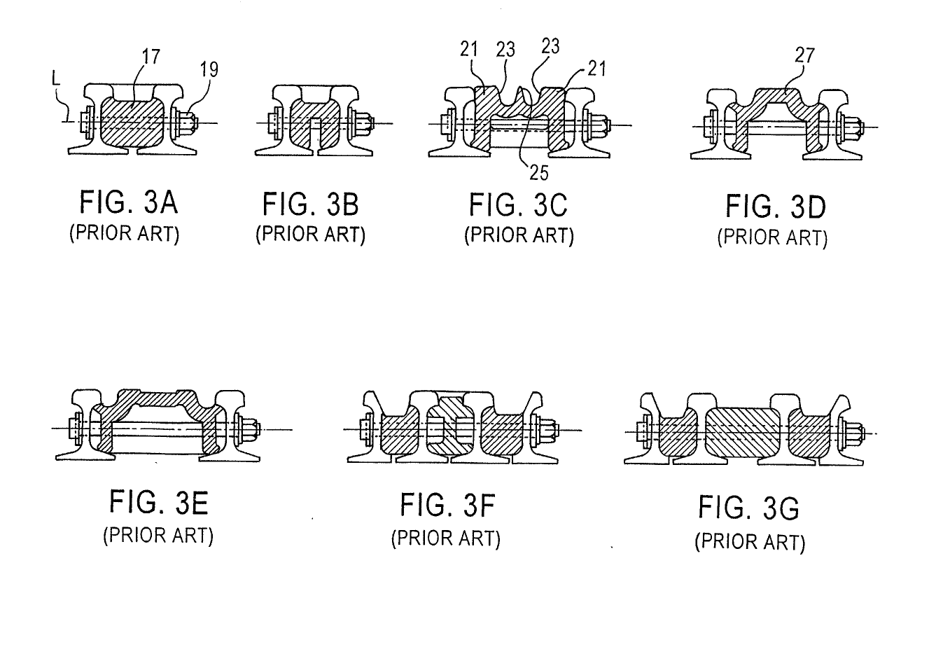

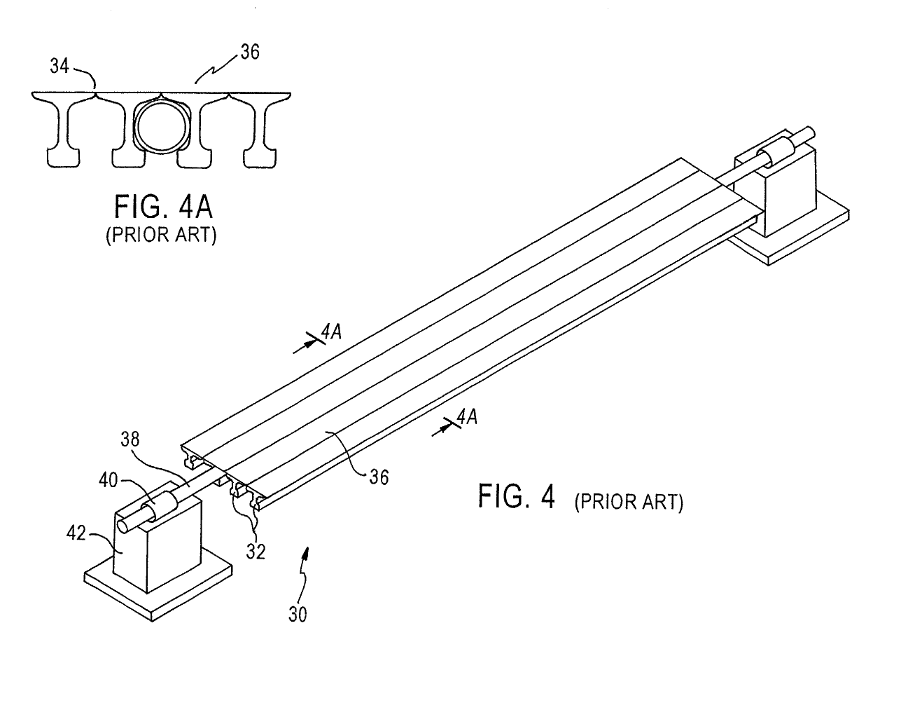

Once this cutting is completed, the end mill cutting elements are then actuated to grind the flange ways 23 to a proper profile. Since the flange ways are surfaces that are inclined from the vertical (see e.g. FIG. 3), the end mill cutting elements can be appropriately inclined by manual operation of the hand wheel associated with the miling machine. However, since these flange ways also extend at an acute angle to the longitudinal axis, it will now be appreciated that the top support frame 1040 may be rotated about the vertical axis of the piston rod 1060 into a non-parallel position relative to the lower attachment frame by first loosening the nut and bolt arrangements followed by pneumatic actuation of the piston which lifts the piston rod and thereby the frame connecting the top milling machine support frame relative to the lower attachment frame (see FIG. 17). Once the top support frame 1040 is lifted, the support frame is free to rotate under the guiding action of the bolts traversing through the arcuate slots 1088, 1300 until a desired angular orientation is reached whereby the end mill cutting elements are in collinear alignment with the flange way 23 to be cut. Easy manual rotational movement of the top support frame 1040 is further made possible by providing low friction plastic material 1250 between opposing surfaces of the top and bottom frames to facilitate low frictional sliding movement. After the top frame 1040 is angularly offset relative to the lower attachment frame 1020, the nuts and bolts are retightened and the piston rod 1060 is lowered by disrupting the supply of pneumatic fluid to the piston.

Limit switches may be provided on the milling machine support base to contact emergency stationary stops located at opposite longitudinal ends of the support frame. If the milling machine support base reaches one the end positions whereby the limit switch contacts the emergency stop, it will be appreciated that power to the base drive motor is disrupted to automatically stop the machine.

An air pump is attached to the A-frame support at one or both opposite ends of the lower attachment frame and this air pump may be hand-operated to enable the workmen to easily supply pneumatic pressure to the lifting piston.

It will be readily seen by one of ordinary skill in the art that the present invention fulfills all of the objects set forth above. After reading the foregoing specification, one of ordinary skill will be able to effect various changes, substitutions of equivalents and various other aspects of the invention as broadly disclosed herein. It is therefore intended that the protection granted hereon be limited only by the definition contained in the appended claims and equivalents thereof

What is claimed is:

1. a portable milling machine, comprising:
(a) A milling head mounted to a support base;
(b) A support frame to which the support base is movably mounted; and
(c) An attachment frame connected to extend below the support frame for attaching the milling machine to a supporting structure.

2. The portable milling machine of claim 1, further comprising at least one slide rail attached to the support frame and at least one bearing attached to the support base in sliding contact with the slide rail.

3. The portable milling machine of claim 2, further comprising a driving mechanism movably connecting the support base to the support frame for sliding movement along the slide rail.

4. The portable milling machine of claim 3, wherein said driving mechanism is a motor connected to a pinion and a rack extending longitudinally on the support frame in meshing contact with the pinion to permit movement of the milling head and support base in a longitudinally or Y direction of the frame.

5. The portable milling machine of claim 4, further comprising a gear reducing box connected between the motor and pinion.

6. The portable milling machine of claim 1, wherein said support frame is attached to the attachment frame with an attachment mechanism operable to enable relative orientation of the support frame and attachment frame such that longitudinal axes of both frames are coaxially aligned with each other in a first orientational position, and said longitudinal axes are angularly offset from each other in a second orientational position, whereby in said second orientational position the milling head is operable to move in the angularly offset direction.

7. The portable milling machine of claim 6, wherein said attachment mechanism includes a plurality of plates attached to one of the attachment frame and support frames and a plurality of clamping arrangements attached to the other of the attachment and support frames, each plate having an arcuately extending slot with the clamping arrangements extending therethrough, wherein unclamping of the clamping arrangement permits relative rotation about a rotational axis extending in the vertical or Z direction of the machine and clamping of said clamping arrangements fixes the relative position of the frames between said first and second orientational positions.

8. The portable milling machine of claim 7, wherein the radii of curvature of said arcuately extending slots have a common center coincident with the rotational axis.

9. The portable milling machine of claim 8, wherein said clamping arrangements are nut and bolt arrangements.

10. The portable milling machine of claim 7, wherein said attachment mechanism further includes a piston attached to one of the support and attachment frames and a piston rod extending therefrom to connect to the other of the support and attachment frames, whereby movement of the piston rod in one direction tends to separate the frames to permit movement therebetween between said first and second orientational positions.

11. The portable milling machine of claim 10, wherein said piston is a lifting piston connected to the attachment frame and the piston rod is connected to the support frame, whereby rod extension is operable to lift the support frame from the lower attachment frame.

12. The portable milling machine of claim 11, wherein said piston is mounted in an overhead position above the attachment and support frames to a first connecting frame projecting upward from the attachment frame, said piston rod being attached to the support through a second connecting frame projecting upward from the support frame.

13. The portable milling machine of claim 12 further comprises a bearing connecting the piston rod to the second frame.

14. In combination, comprising:
(a) A portable milling machine including:
(i) A milling head mounted to a support base;
(ii) A support frame to which the support base is movably mounted; and
(iii) An attachment frame connected to extend below the support frame for attaching the milling machine to a supporting structure; and
(b) A railroad frog reconditioning and welding table.

15. The combination of claim 14, wherein said attachment frame is dimensioned to be positioned on the frog table so that the frog is located within the support frame for cutting engagement with the milling head.

16. The combination of claim 15, wherein said attachment frame includes bolt receiving openings in operative alignment with corresponding openings formed on the frog table.

17. The combination of claim 15, comprising:
(a) A table including:
(i) A pair of longitudinally extending support beams; and
(ii) a stiffener plate assembly including a plurality of transversely extending stiffener plates attached to the support beams at longitudinally spaced intervals from each other; and
(b) A pair of clamping members adapted to be operatively connected to the table for clamping the frog at opposite ends thereof by applying a clamping force directed downwardly towards the support beams.

18. The combination of claim 17, wherein said pair of support beams includes a pair of I-beams extending in parallel spaced relation to each other.

19. The combination of claim 18, wherein each said stiffener plate is of rectangular configuration having cut out corners dimensioned to interfit with an inwardly extending flange of an associated one of said I-beams so that upper and lower edge surfaces of said plate are respectively coplanar with associated upper and lower surfaces of adjacent I-beam flanges.

20. The combination of claim 19, further comprising a support member mounted to extend above the support beams to define an upwardly directed support surface thereon.

21. The combination of claim 20, further comprising:
(i) A support shaft extending longitudinally through the stiffener plate assembly;
(ii) A pair of bearings located at opposite ends of said support shaft in rotary supporting engagement therewith; and
(iii) A rotating arrangement operatively connected to at least one of said ends of said support shaft for enabling controlled rotation of said table about the longitudinal axis of rotation of said shaft

22. The combination of claim 21, wherein the rotating arrangement is a reducing gear arrangement including a worm gear reducing case operatively connected to a hand wheel for rotating said frog table.

23. The combination of claim 17, further comprising a counterweight arrangement adapted to be secured to a bottom portion of the table located below the center of gravity to counterbalance the table in cooperation with the off-center spacing of the shaft when a frog is clampingly secured to the top of the table.

24. The combination of claim 16, further comprising a plurality of pairs of attachment ears attached to the sides of the table to provide tie-down points enabling the clamping members to be attached to the table at selected locations, said tie-down points being said bolt receiving openings formed on said frog table.

25. A method of milling a railroad frog after defective surfaces thereof have been reconditioned through welding on a railroad frog conditioning and welding table, comprising the steps of:
(a) Leaving the reconditioned frog on the frog table;
(b) Positioning a milling head above the frog after clamping a milling head support frame to the frog table; and
(c) Moving the milling head over the frog so that milling head cutting elements cut the reconditioned frog surfaces to a desired final profile.

26. The method of claim 25, wherein said milling head is moved above the frog through sliding interaction with the support frame.

27. The method of claim 26, wherein said support frame is bolted to the frog table.

28. The method of claim 27, wherein the support frame and frog table have aligned openings to permit bolted engagement therebetween.

29. The method of claim 28, wherein the bolt receiving openings in the frog table are tie-down points used for clamping opposite ends of the frog against the table.

30. The method of claim 25, comprising the further step of orienting the support frame on the frog table so that the milling head moves along the longitudinal axis of the frog table.

31. The method of claim 30, comprising the further step of angularly offsetting the support frame relative to the frog table so that the milling head moves along a linear axis defined by the flange ways of the reconditioned frog.

32. The method of claim 31, comprising the further step of further angularly offsetting the support frames relative to the frog table so that the milling head cuts the other of the flange ways along an offset linear axis.
